(19) United States
(12) Patent Application Publication
(10) Pub. No.: US 2026/0297260 A1
(43) Pub. Date: Oct. 1, 2026

(54) POLYIMIDES: COMPOSITIONS, METHODS OF MAKING, AND PARTS MADE THEREFROM

(71) Applicant: DUPONT SPECIALTY PRODUCTS USA, LLC, Wilmington, DE (US)

(72) Inventors: Darin PETERSON, Wilmington, DE (US); Christopher Scott STENTA, Newark, DE (US); Vivek KAPUR, Wilmington, DE (US)

(21) Appl. No.: 19/477,085

(22) PCT Filed: Jun. 14, 2024
(86) PCT No.: PCT/US2024/033939

§ 371 Date: Oct. 20, 2025

Related U.S. Application Data
(60) Provisional application No. 63/508,727, filed on Jun. 16, 2023.

(51) Int. Cl. C08G 73/10; C08K 3/04

(52) U.S. Cl. CPC C08G 73/1042; C08G 73/1007; C08G 73/1071; C08K 3/04

(57) ABSTRACT

A polyimide composition comprising particles of a polyimide polymer derived from (i) ODA, (ii) PMDA, (iii) PPD, and (iv) BPDA monomers, wherein, when the polyimide composition consists of the particles of the polyimide polymer, the polyimide composition has an apparent density of ≤0.25 grams per cubic centimeter.

### CROSS-REFERENCE TO RELATED APPLICATIONS

None

### FIELD OF THE INVENTION

The present invention relates, generally, to polyimide compositions, parts made from polyimide compositions, and methods of making polyimide compositions and parts.

### BACKGROUND OF THE INVENTION

Parts made from polyimide compositions are known. For example, parts have been made from polyimide compositions derived from 4, 4′oxydianaline (ODA) and pyromellitic dianhydride (PMDA) and, separately, derived from p-phenylene diamine (PPD), m-phenylenediamine (MPD), and biphenyl tetracarboxylic acid dianhydride (BPDA). However, with increasing demands for higher performance and more demanding applications, limitations of polyimides derived from these polyimides have become apparent. For example, improved toughness is desired from parts derived from these polyimide compositions in some applications. Increased toughness can equate to improved product life in use. Higher toughness of the polymer also provides the design engineers a greater flexibility in designing parts that can withstand more challenging operating conditions than may be feasible with a brittle polymer.

One such application where improved toughness is desired of polyimide parts is in clutches for primary and secondary transmissions. Polyimides may be formed into rollers that may be used in clutches (clutch rollers). As engines continue to get more powerful, more stress is being applied to clutch rollers made from existing polyimide materials, and these more demanding conditions have caused some polyimide parts to fail earlier than desired resulting in costly repairs.

Therefore, there exists a need for new polyimide compositions and methods of making polyimide compositions that provide improved toughness when formed into parts such as clutch rollers.

### BRIEF SUMMARY OF THE INVENTION

The present invention is directed to a polyimide composition comprising particles of a polyimide polymer derived from (i) ODA, (ii) PMDA, (iii) PPD, and (iv) BPDA monomers, wherein, when the polyimide composition consists of the particles of the polyimide polymer, the polyimide composition has an apparent density of ≤0.25 grams per cubic centimeter.

The present invention is further directed to a method of making a polyimide composition comprising combining (i) ODA, (ii) PMDA, (iii) PPD, (iv) BPDA and (v) a solvent for a time and at conditions sufficient to form a reaction product mixture comprising a polyamide and solvent; heating the reaction product mixture at a temperature≥110 degrees C. and for a time sufficient to form a solid polyimide particles and to remove water; filtering and washing the formed solid polyimide particles to form washed solid polyimide particles; and drying the washed solid polyimide particles to form the polyimide composition comprising dried polyimide particles having an apparent density of less than 0.25 g/cm³.

The present invention is still further directed to a part formed from a polyimide composition comprising particles of a polyimide polymer derived from (i) ODA, (ii) PMDA, (iii) PPD, and (iv) BPDA monomers, wherein, when the polyimide composition consists of the particles of the polyimide polymer, the polyimide composition has an apparent density of ≤0.25 grams per cubic centimeter.

The present invention provides polyimide compositions that may be formed into parts with increased toughness and density and providing improved life span in applications with the ability to withstand greater stresses during typical use. The present invention further provides polyimide compositions with improved anti-friction or lubrication properties.

### BRIEF DESCRIPTION OF THE DRAWINGS

FIG. 1 represents friction and wear test material machined to a specific shape and size for testing on a Falex instrument.

FIG. 2 represents tensile strength of sintered parts plotted against % BPDA and % PPD in the polymer tested. The open symbols represent polymer compositions formed by blending BPDA-PPD homopolymer and PMDA-ODA homopolymer in different proportions. Filled symbols represent different copolyimide compositions of this invention. The tensile strength for copolymers is significantly higher than for blended polymers having the same composition of monomers.

FIG. 3 represents % Elongation at break of sintered parts plotted against % BPDA and % PPD in the polymer being tested. The open symbols represent polymer compositions formed by blending BPDA-PPD homopolymer and PMDA-ODA homopolymer in different proportions. Filled symbols represent different copolyimide compositions of this invention. The % elongation for copolymers is significantly higher than for blended polymers having the same composition of monomers.

FIG. 4 represents polymer toughness of sintered parts plotted against % BPDA and % PPD in the polymer being tested. The open symbols represent polymer compositions formed by blending BPDA-PPD homopolymer and PMDA-ODA homopolymer in different proportions. Filled symbols represent different copolyimide compositions of this invention. The toughness for copolymers is significantly higher than for blended polymers having the same composition of monomers.

### DETAILED DESCRIPTION OF THE INVENTION

As used herein, “BPDA” means biphenyl tetracarboxylic acid dianhydride; PMDA means pyromellitic dianhydride; “PPD” means p-phenylene diamine; and “ODA” means 4, 4′-oxydianaline.

As used herein in reference to the polyimide, “homopolymer” means a polymer having the same repeating unit throughout the polymer backbone, which is formed from the reaction of a dianhydride and the diamine.

A polyimide composition, comprising: particles of a polyimide derived from (i) ODA, (ii) PMDA, (iii) PPD, and (iv) BPDA monomers, wherein, when the polyimide composition consists of the particles of the polyimide polymer, the polyimide composition has an apparent density of ≤0.25 grams per cubic centimeter.

ODA, PMDA, PPD, and BPDA are as defined above.

The polyimide is a polymer comprising repeat units with imide functionality. One skilled in the art would know what a polyimide and imide functionality are. The particles of polyimide are derived from (i) ODA, (ii) PMDA, (iii) PPD, and (iv) BPDA monomers as, for example, described below for the method of producing the polyimide composition. One skilled in the art would know how to derive the particles of the polyimide based on the method described below. The size, shape and morphology of the particles of the polyimide can vary depending upon the ratio of monomers used and the conditions used in the process. One measure of the size, shape and morphology of the particles of polyimide is apparent density. The particles of polyimide have an apparent density of less than 0.25 grams/cm³, alternatively 0.10 grams/cm³ to 0.25 g/cm³, alternatively from 0.15 grams/cm³ to 0.25 grams/cm³, alternatively from 0.10 to 0.20 grams/cm³. Apparent density is measured as described in the examples and is in reference to the particles of polyimide without the addition of filler or any other additive. For example, apparent density of the particles of polyimide may be measured using a volumeter with the test method described in ASTM-01895-17 titled “Standard Test Methods for Apparent Density, Bulk Factor, and Pourability of Plastic Materials.”

Addition of filler can modify the apparent density such that the apparent density of the polyimide composition is modified. Thus, when filler is included in the polyimide composition, the apparent density refers to the particles of polyimide derived from the same monomer ratios and using the same process and conditions but without any filler added. It is believed that the apparent density is a measure of particle morphology, which affects the ability of the particles of polyimide to form tough parts with sufficient specific gravity.

As used herein, “when the polyimide composition consists of the particles of the polyimide polymer” means that the polyimide composition contains only the particles of the polyimide polymer and no other added materials, except residual materials such as unreacted reactants and/or impurities. The particles of polyimide and/or polyimide composition may include additional materials, such as filler. However, when the polyimide composition comprises a filler, the particles and or polyimide composition, if made without the filler with the same monomers, ratio of monomers, conditions, and process used to make the polyimide composition with the filler, has an apparent density of ≤0.25 grams/cubic centimeter.

In one embodiment, a part made from the polyimide composition has a toughness greater than a part made from a mixture of polymers A) and B), wherein polymer A) is derived from only ODA and PMDA monomers, and polymer B) is derived from only PPD and BPDA monomer, and wherein the mole ratio of ODA, PMDA, PPD, and BPDA in the part made from the polyimide composition is the same as in the mixture of homopolymer A) and homopolymer B).

As used herein, “part” has the meaning as typically known in the art. In one embodiment, the part is a clutch roller. Examples of parts include, but are not limited to, a seal ring, a spherical washer, a compressor seal, a ball bearing cage, planetary gear set washer for electric vehicles, a transmission washer for replacement of metallic thrust needle bearings, a main bearing or lower bearing in scroll compressors used in heating and air conditioning applications, a valve seat or poppet in high pressure gas valves, a friction or wear component in a wind turbine, and a Variable Stator Vain (VSV) or Variable Inlet Guide Vain (VIGV) in compressors of jet engines. The part may be used in the areas of aerospace, transportation, and industrial. Polyimides compositions of the present invention may be used as sealing devices in electrochemical batteries as lithium batteries. The part may be made by methods known in the art. One skilled in the art would know how to mold the polyimide composition to form a part.

Toughness of a material and/or part is defined by its ability to absorb energy and plastically deform without fracturing. It is also defined as the amount of energy per unit volume that the material can absorb before rupturing. Yet another definition is the resistance that the material offers to fracture when stress is applied. Toughness is determined by calculating the area under the stress strain curve where stress is on the y-axis and strain on the x-axis. One skilled in the art would know how to determine the stress and strain of a part made from the polyimide composition. For the purpose of this invention, toughness was determined and being reported for tensile dog bone shaped bars under tensile stress. Tensile stress strain curves for the polyimide dog bone shapes were obtained using an Instron tester. The toughness was obtained by numerically integrating the area under the stress strain curve and is reported in Ksi unit.

A method of making a polyimide composition, comprising:
combining (i) ODA, (ii) PMDA, (iii) PPD, (iv) BPDA and (v) a solvent for a time and at conditions sufficient to form a reaction product comprising a polyamide and solvent;
heating the reaction product at a temperature and time sufficient to remove water and to form particles of a polyimide;
filtering and washing the formed particles of polyimide;
drying the washed polyimide particles to form the polyimide composition, wherein the polyimide composition comprises the particles of polyimide;
wherein when the polyimide composition consists of the particles of the polyimide polymer, the polyimide composition has an apparent density of ≤0.25 grams per cubic centimeter.

The (i) ODA, (ii) PMDA, (iii) PPD, (iv) BPDA and (v) a solvent are combined for a time and at conditions sufficient to form a reaction product comprising a polyamide and the solvent. As used here, “polyamide” includes polyamide acid. Methods known in the art may be used to combine the monomers.

The temperature at which the monomers (i)-(iv) and solvent are combined is a temperature sufficient to cause a reaction, alternatively from room temperature to elevated temperature, alternatively room temperature, alternatively from room temperature to 120 degrees Celsius, alternatively elevated temperature to 90 degrees Celsius, alternatively from 50 to 80 degrees Celsius.

The polyamide reaction product is subjected to conditions sufficient, alternatively are heated, alternatively are heated at a temperature from 70° C. to 190° C., alternatively 110° C. to 170° C., alternatively 110° C. to 150° C., to convert the polyamide to insoluble polyimide and remove water. The heating may be conducted in a high pressure vessel such as a Parr reactor at elevated pressure. One skilled in the art would know how to heat the polyamide in solvent to convert to a polyimide.

The combining and heating steps may be conducted in the same or different vessels, alternatively are conducted in separate vessels.

The particles of polyimide are filtered and washed. The polyimide is filtered using methods known the art. For example, the polyimide and solvent may be passed through a Buchner funnel to recover the polyimide. One skilled in the art would know how to filter the polyimide. The polyimide is washed with solvent and dried. One skilled in the art would know how to wash and dry the polyimide. The polyimide is dried at a temperature from 100° to 230° C., alternatively 140° C. to 190° C., alternatively about 180° C., to convert the polyimide slurry to a polyimide resin in the form of a powder (or particles). The filtering and washing are typically done into a separate vessel than the combining and reaction steps.

When the polyimide composition consists of the particles of the polyimide polymer, the polyimide composition has an apparent density of ≤0.25 grams per cubic centimeter as described herein above.

The method of making a polyimide composition may further comprise combining a filler with the reaction product prior to or during the heating step. The filler is as described herein. The filler may alter the apparent density of the particles of polyimide. The apparent density is in reference to an unfilled composition and unfilled particles of polyimide.

The polyimide may be, for example, derived from (i) ODA, (ii) PMDA, (iii) PPD, and (iv) BPDA monomers using a solution imidization process according to the following in one embodiment. The diamines (PPD and ODA) are generally first dissolved in a solvent to form the diamine component. In general, after dissolving the diamine component in the required concentration of the solvent, the dianhydrides (BPDA and PMDA) are added to the reaction solution in substantially equimolar quantities to form a polyamide acid (PAA) polymer solution. In one embodiment, the polyimide polymer has a slight molar excess of either the dianhydride or diamine component is possible, alternatively a molar excess of 0.5 to 1.0% of the diamine component, which has been found to provide good results. In another embodiment, a stoichiometry close to equimolar diamine and dianhydride is used. The resulting PAA polymer solution is transferred over a period of time to a heated solution of the solvent. The transferred PAA polymer solution is continuously heated and agitated to complete the reaction of soluble PAA to a slurry of insoluble polyimide. The resulting polyimide slurry is washed with solvent and dried at 100° to 230° C., alternatively 110° to 190° C., alternatively 110-150 degrees C., to convert the polyimide slurry to a polyimide resin in the form of a powder or particles having a high surface area. The optimum temperature results in greater process efficiency and better physical properties, such as apparent density, of the particles or parts made from the particles of polyimide.

The solvent includes, but is not limited to, the organic solvents whose functional groups will not react with either of the reactants (the anhydrides or the diamines) to any appreciable extent. The solvent may exhibit a pH of about 8 to 10, which can be measured by mixing the solvent with a small amount of water and then measuring with pH paper or probe. Such solvents include, for example, pyridine. Other solvents that necessarily do not display a pH between 8 and 10 may also be used and additives, such as B-picoline, may be added to change the pH of the solvent. Examples of solvents that may be used include, but are not limited to, dimethylacetamide (DMAC), n-methyl-2-pyrollidone (NMP), dimethylsulfoxide (DMSO) and B-picoline and mixtures of thereof. Of the solvents disclosed in Galland U.S. Pat. No. 3,179,614 to Edwards, pyridine (K=1.4×10) is a preferred solvent for these reactants in the polymerization reaction as well as functioning as the catalyst. For a dianhydride and a diamine to react to form a PAA polymer solution, a basic catalyst is needed. Since pyridine is a basic compound, it functions as both a catalyst and a solvent.

The quantity of solvent is important in obtaining a product having ideal particle size, low apparent density and high surface area. In particular, the solvent should be present in a quantity such that the concentration of the PAA polymer Solution is about 1 to 15% by weight solids, preferably from about 5 to 12% by weight solids. One skilled in the art would be familiar with processes to make the polyimide compositions and how to select an appropriate quantity of solvent.

In one embodiment, a part made from the polyimide composition has a toughness greater than a part made from a mixture of polymers A) and B), wherein polymer A) is derived from ODA and PMDA monomers and polymer B) is derived from PPD and BPDA monomers, alternatively B) is derived from PPD, MPD, and BPDA, and wherein the mole ratio of ODA, PMDA, PPD, and BPDA in the polyimide is the same as in the mixture of polymer A) and polymer B).

Polymer A) is derived from ODA and PMDA monomers, wherein the mole ratio of ODA and PMDA in the polymer A) is the same as in the polyimide composition derived from ODA, PMDA, PPD, and BPDA used to make the part. Polymer B) is derived from PPD and BPDA monomers, alternatively B) is derived from PPD, MPD, and BPDA, wherein the mole ratio of PPD and BPDA monomers is the same as in the polyimide composition derived from ODA, PMDA, PPD, and BPDA used to make the part.

Examples of polymer A) include a polymer made with a mole ratio of about 45:55 to 55:45, alternatively about 50:50, ODA to PMDA. Examples of polymer B) include a polymer made with a mole ratio of about 45:55 to 55:45, alternatively about 50:50, PPD to BPDA.

Polymer A) and polymer B) are made according to the method for making the polyimide composition described and exemplified herein. To make a part from polymers A) and B), a physical mixture of particles of polymers A) and B) are made by mixing with typical mixing equipment for making the particles of polyimide. The physical mixture is then formed into a part by molding the mixture at conditions sufficient to form a part, alternatively at elevated pressures and ambient temperature as described below for polyimide compositions, alternatively at pressures of about from 20,000 to 100,000 psi (345 to 690 MPa) or preferably from 50,000 to 100,000 psi at ambient temperatures.

A polyimide composition, comprising: a polyimide derived from (i) ODA, (ii) PMDA, (iii) PPD, and (iv) BPDA monomers, wherein a part made from the polyimide composition has a specific gravity greater than a mixture of a polymer A) and a polymer B), wherein polymer A) is derived from ODA and PMD monomers and polymer B) is derived from PPD and BPDA monomers, and wherein the mole ratio of ODA, PMDA, PPD, and BPDA in the polyimide is the same as in the mixture of polymer A) and polymer B).

The monomers ODA, PMDA, PPD, BPDA, polymer A) and B) and the mole fraction of ODA of ODA, PMDA, PPD, and BPDA, are as described above.

Specific gravity is as known in the art. One skilled in the art would understand how to measure and calculate specific gravity of a part. In one embodiment, the specific gravity is greater than 0.138 g/cm³ from 0.138 g/cm³ to 1.54 g/cm³.

The specific gravity refers to that of a part made from the polyimide composition without the addition of other additives, such as filler. Filler and other additives can modify the specific gravity; however, the specific gravity of a part made from a filled polyimide composition will be greater than that of a part made from the mixture of polymers A and B. When filler is included in the polyimide composition, the specific gravity of a part refers to that of a part formed from a polyimide composition derived from the same monomer ratios and using the same process and conditions but without any filler added.

Specific gravity mya measured according to methods known in the art. One skilled in the art would understand how to measure specific gravity. Specific gravity of the parts was calculated by the following equation herein:

$$Specific gravity = \frac{weight of part in air}{( weight of part in air - weight of part immersed in water )} .$$

A polyimide composition, comprising:
a polyimide derived from (i) ODA, (ii) PMDA, (iii) PPD, and (iv) BPDA monomers, wherein the sum of the mole fractions of BPDA and PMDA is about 1 and the sum of the mole fractions of PPD and ODA is about 1, and wherein the relationship of the mole fractions of BPDA on a dianhydride basis and the mole fraction of PPD on a diamine basis are PPD−0.2<BPDA, 0.05<BPDA<0.95, and 0.05<PPD<0.95.

In one embodiment, the sum of the mole fractions of BPDA and PMDA is about 1 and the sum of the mole fractions of PPD and ODA in the polyamide is about 1 and the relation between the mole fraction of BPDA on a dianhydride basis and mole fraction of PPD on a diamine basis are PPD−0.2<BPDA, 0.05<BPDA<0.95, and 0.05<PPD<0.95, alternatively. The mole fraction of BPDA is based on the total dianhydride, and the mole fraction of PPD is based on total diamine.

In one embodiment, the mol % of BPDA in relation to the other monomers combined to make the particles of polyimide is ≥(mol % of PPD+0.2). This mol % of BPDA will produce a part with adequate toughness.

One skilled in the art would know how to calculate mol % and mole fractions of the monomers that falls withing the ranges described and modify the method of making described above to produce a polyimide having the monomer fractions and mol % described.

In one embodiment, a part made from the polyimide composition has a toughness greater than 0.80 Ksi, alternatively greater than 0.85 Ksi, alternatively from 0.80 KSI to 5 Ksi, alternatively from 0.80 Ksi to 1.5 Ksi, alternatively from 0.85 Ksi to 1.0 Ksi.

The toughness refers to that of a part made from the particles of polyimide without the addition of other additives, such as filler. Filler and other additives can affect the toughness. Thus, when filler is included in the polyimide composition, the toughness of a part, as used herein, refers to that of a part formed from a polyimide composition derived from the same monomer ratios and using the same process and conditions but without any filler added.

The ODA, PMDA, PPD, BPDA, the making a part from the polyimide composition, and how to determine a part's toughness are as described above. One skilled in the art would know how to determine the toughness of a part derived from the monomers listed from the description above.

A polyimide composition, comprising:
a polyimide derived from (i) ODA, (ii) PMDA, (iii) PPD, and (iv) BPDA monomers and comprising one or more of the following repeat units

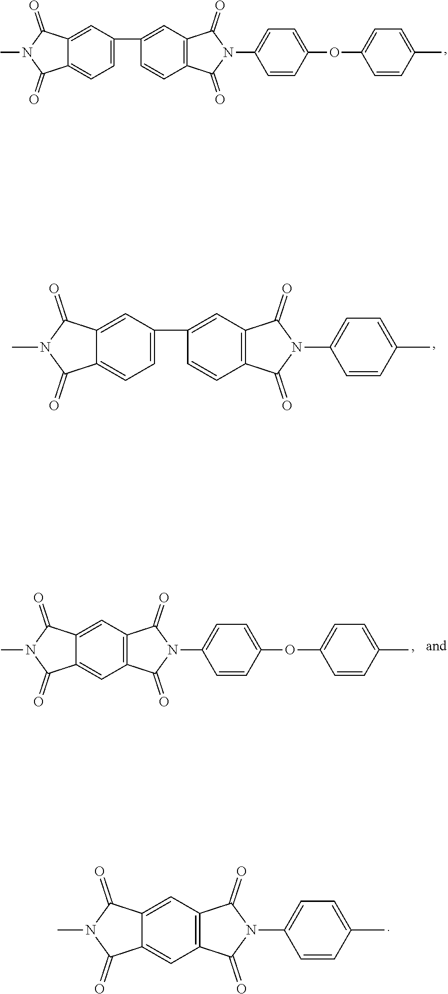

The surface area for a polyimide in the polyimide composition of this invention is typically at least 20 m²/g. It is preferable that the surface area be at least 75 m²/g to achieve acceptable physical properties and for ease of processability.

The average molecular weight (Mw) of the polyimide as measured by GPC is greater than 50,000, preferably greater than 100,000, alternatively greater than 150,000 g/mol. One skilled in the art would know how to determine molecular weight and how to control molecular weight during the production of the polyimide.

In one embodiment, the polyimide composition further comprises a filler. Examples of fillers include, but are not limited to, carbonaceous fillers such as graphite and carbon fiber, and inorganic fillers such as Kaolinite clay, molybdenum sulfide, tungsten sulfide and boron nitride and polymeric fillers such as polymer and copolymers of tetra-fluoroethylene to improve wear and frictional characteristics while retaining the excellent mechanical properties and oxidative stability of the polyimides. In addition to improving friction and wear properties, fillers may also be added to affect other properties of the polymer such as but not limited to increasing the stiffness or rigidity of the polymer and the part derived from the polymer. Fillers can be present in quantities ranging from 0.1 to 80 wt. %. The particular filler or fillers selected, as well as the quantities used, will, of course, depend on the effect desired in the final composition, as will be evident to those skilled in the art. These fillers are typically incorporated into the heated solvent prior to transfer of the PAA polymer Solution so that the polyimide is precipitated in the presence of the filler which is thereby incorporated. The form of the fillers will depend on the function of the filler in the final products. For example, the fillers can be in particulate or fibrous form.

After the addition of filler the apparent density may be above 0.25 g/cm³.

A part comprising a polyimide composition described above, wherein the part has a toughness≥0.80 Ksi, a specific gravity of ≥1.38 g/cm³, or a toughness≥0.80 Ksi and a specific gravity of ≥1.4 g/cm³. Toughness and specific gravity are as described above.

The polyimide composition can be molded under elevated pressures to a wide variety of configurations to form parts, alternatively a part can be cold compact molded to form a green part which is then heated to a temperature above 400° C., alternatively a part may be made by hot pressing the polyimide composition where high pressure and temperature are applied at the same time. It has been found to be particularly convenient to mold the polyimide composition at pressures of about from 50,000 to 100,000 psi (345 to 690 MPa) at ambient temperatures. Lower pressures may also be used but that could increase the porosity of the final part and could also compromise the strength of the part. One skilled in the art would know how to make molded parts from the polyimide compositions of the invention and polyimide compositions made by methods of the invention.

Parts made from the polyimide composition of the invention and further comprising filler have at least 50%, alternately 75%, alternately 100% lower wear compared to a part made from a mixture of polymers A and B, described above, having the same monomer composition and filler as the polyimide composition. Wear is determined according the procedure described in the examples section.

The invention may include the following aspects:
1. A polyimide composition, comprising: a polyimide derived from (i) ODA, (ii) PMDA, (iii) PPD, and (iv) BPDA monomers, wherein the polyimide has an apparent density of ≤0.25 grams per cubic centimeter.
2. The polyimide composition of aspect 1, wherein a part made from the polyimide composition has a toughness greater than 0.80 Ksi. and a specific gravity of ≤1.4 g/cm³.
3. A polyimide composition, comprising: a polyimide derived from (i) ODA, (ii) PMDA, (iii) PPD, and (iv) BPDA monomers, wherein the polyimide has a specific gravity greater than a mixture of a polymer A) and a polymer B), wherein polymer A) is derived from ODA and PMD monomers and polymer B) is derived from PPD and BPDA copolymers, and wherein the mole fractions of ODA, PMDA, PPD, and BPDA in the polyimide is the same as in the mixture of polymer A) and polymer B).
4. A polyimide composition according to aspect 3, wherein the part made from the polyimide composition has a specific gravity greater than 1.4 g/cm³.
5. A polyimide composition, comprising: a polyimide derived from (i) ODA, (ii) PMDA, (iii) PPD, and (iv) BPDA monomers, wherein the sum of the mole fractions of BPDA and PMDA is about 1 and the sum of the mole fractions of PPD and ODA is about 1, and wherein the relationship of mole fraction of BPDA and mole fraction of PPD is PPD−0.2<BPDA, 0.05<BPDA<0.95, and 0.05<PPD<0.95.
6. A polyimide composition, comprising: a polyimide derived from (i) ODA, (ii) PMDA, (iii) PPD, and (iv) BPDA monomers and comprising one or more of the following repeat units

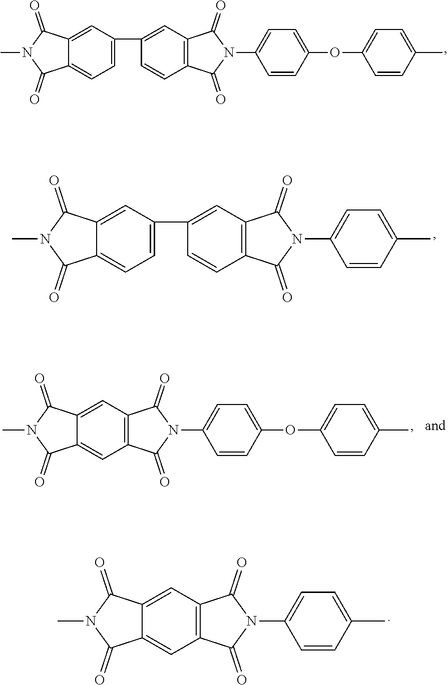

7. A polyimide composition, comprising: a polyimide derived from (i) ODA, (ii) PMDA, (iii) PPD, and (iv) BPDA monomers, wherein the part made from the polyimide composition has a toughness greater than 0.80 Ksi.
8. A polyimide composition, comprising: a polyimide derived from (i) ODA, (ii) PMDA, (iii) PPD, and (iv) BPDA monomers wherein the part made from the polyimide composition has a specific gravity greater than 1.4 g/cm³.
9. The polyimide composition according to any one of the preceding aspects, further comprising a filler.
10. The polyimide composition according to any one of the preceding aspects, wherein the mole ratio of diamine monomers to anhydride monomers is about 1.
11. A part, comprising; the polyimide composition according to any one of aspects 1 to 10.
12. The part according to aspect 11, wherein the part is molded.
13. The part according to aspect 10 or 11, wherein the part is a clutch roller.
14. A method of making a polyimide composition, comprising: combining (i) ODA, (ii) PMDA, (iii) PPD, (iv) BPDA and (v) a solvent for a time and at conditions sufficient to form a reaction product mixture comprising the polyamide and solvent; heating the reaction mixture at a temperature≥110° C. and for a time sufficient to form particles of polyimide and to remove water; filtering and washing the solid polyimide particles; and drying the solid polyimide particles to form the polyimide composition comprising the solid polyimide particles, wherein the temperature to which the reaction mixture is heated is selected to give solid polyimide particles having an apparent density of less than 0.25 g/cm³.
15. The method according to aspect 14, further comprising combining the dried polyimide with a filler.
16. The method according to aspects 14 or 15, further comprising the steps of sintering and molding the dried polyamide or dried polyimide and filler to form the part.
17. The method according to aspect 16, wherein the part has a toughness greater than 0.80 Ksi.
18. The method according to one of aspects 16 or 17, wherein the part has a specific gravity greater than a part made from mixture of a polymer A) and a polymer B), wherein polymer A) is derived from ODA and PMD monomers and polymer B) is derived from PPD and BPDA, and wherein the mole composition of ODA, PMDA, PPD, and BPDA in the polyimide is the same as in the mixture of polymer A) and polymer B).
19. The method according to any one of aspects 16-18, wherein the part has a specific gravity greater than 1.4 g/cm³.
20. The method according to any one of aspects 14-19, wherein the relationship of the mole fraction of BPDA and mole fraction of PPD is PPD−0.2<BPDA<PPD+0.2, 0.05<BPDA<0.95, and 0.05<PPD<0.95.
21. A part made according to the method of any one of aspects 16-20.
22. The part according to aspect 21, wherein the part is a clutch roller, a seal ring, spherical washer, compressor seal, lip seal, valve seat, ball bearing cage, and actuating disc.
23. The part according to aspect 21, wherein a part made from the polyimide composition further comprising filler has at least 50% lower wear compared to a part made from homopolymers of A and B with the same monomer composition and filler.

The polyimide compositions of the invention form parts having increased toughness and specific gravity. The polyimide compositions can be used to make parts for applications such as clutch rollers used in power sport vehicles.

### EXAMPLES

The following examples are included to demonstrate preferred embodiments of the invention, but they should not be considered as limiting the invention, which is delineated in the appended claims. It should be appreciated by those of skill in the art that the techniques disclosed in the examples which follow represent techniques discovered by the inventor to function well in the practice of the invention, and thus can be considered to constitute preferred modes for its practice. However, those of skill in the art should, considering the present disclosure, appreciate that many changes can be made in the specific embodiments which are disclosed and still obtain a like or similar result without departing from the spirit and scope of the invention. All percentages are in wt. % unless otherwise noted. The following table describes the abbreviations used in the examples.

TABLE 1
List of abbreviations used in the examples.

| Abbreviation | Word |
|---|---|
| g | gram |
| Me | methyl |
| wt | weight |
| % | percent |
| mol | mole |
| hr | Hour |
| ° C. | degrees Celsius |
| NA | Not Applicable |
| mL | Milliliters |
| Solids Content | (wt. of dried sample/wt. of initial sample) × |
| | 100 and determined as described herein |
| cm | Centimeter |

In the Examples 1 to 24 and comparative examples 1-2 and 7 to 13 below, copolyimide compositions were prepared using the solution imidization process in which mixtures of diamines derived from p-phenylene diamine (PPD) and 4, 4′ oxydianaline (ODA) were reacted with mixtures of dianhydrides derived from 3,3′,4,4′-biphenyl tetracarboxylic dianhydride (BPDA) and pyromellitic dianhydride (PMDA) in quantities indicated in the examples using a procedure that is approximately analogous to procedures outlined by Gall in U.S. Pat. No. 3,179,631, Endrey in U.S. Pat. No. 3,249,588 and of Delcolibus in U.S. Pat. No. 5,886,129, all of which are hereby incorporated by reference for their description related to the preparation of copolyimide compositions. In order to illustrate the invention, both polymerization and imidization were carried out with pyridine as a solvent.

Polymerization to form polyamic acid (PAA) was carried out in a Chem Glass round bottom 500 ml glass jacketed reaction kettle, with a bottom take off to drain the finished polyamic acid solution. The reaction vessel was agitated by a Cole-Palmer Servo Dyne model 50008 overhead stirrer with a boat type impeller. The temperature in the reaction kettle was controlled by circulating heat transfer fluid from a Huber Ministat cc3 recirculating heater chiller. The circulator used a silicone base heat transfer fluid which is stable up to 150° C.

A typical theoretical batch size for polymerization involved about 60 g of polymer in anhydrous pyridine. Unless stated otherwise, polymerization was carried out at a concentration or solids loading of 10% by weight in pyridine solvent. Solids concentration is being reported based on the weight of polyamic acid (PAA) polymer and not the final imidized polymer. In preparation for a polymerization run, the goal copolymer composition (defined by the mole fraction of the monomers), the polymer concentration and the % monomer imbalance were fixed. Monomer imbalance is defined by the equation below:

$$\% Monomer Imbalance = \frac{( moles of diamines - mol of dianhydrid )}{moles of dianhydrides} \times 100$$

For all illustrative examples presented here, polymerizations were run in a diamine rich environment with the monomer imbalance in the vicinity of 0.75%.

Molecular weight of the polyamic acid (PAA) solution was measured using an Agilent GPC apparatus comprising an Agilent 1290 UHPLC stack, a binary delivery pump, an autosampler, separation column compartment and a UV detector. The GPC was fitted with two stationary phases consisting of two Agilent PLgel 5 μm MIXED-C 300 mm×7.5 mm columns and one PLgel 5 μm Guard column 50 mm×7.5 mm. The instrument was controlled by Chemstation OpenLabs software with a Cirrus GPC add on. The columns were calibrated using polystyrene polymer standards sold by Agilent (Easi Cal PS-1).

The mobile phase for the GPC was prepared by premixing 98.436% dimethyl acetamide (DMAC), 0.357% o-phosphoric acid, 0.942% Tetrahydrofuran (THF) (not stabilized) and 0.265% Lithium Bromide (LiBr). All percentages are by weight. Sample injection volumes were fixed at 2 μl. The mobile phase flow rate was set to 0.5 ml/min. Elution was isocratic. Stop time for the GPC was 55 minutes. The GPC used a UV detector, which was set to detect at 268 nm.

Imidization of the polyamic acid was carried out in a 1000 ml Parr high pressure reactor fitted with an anchor type impeller. A Teledyne ISCO 500 D pump was used to transfer the PAA solution to the high pressure Parr vessel. The PAA solution in the ISCO pump was heated to 70° C. before transferring to the high pressure reactor. The Parr vessel was capable of being heated to 200° C. by electric resistive heaters. The imidization temperature in the Parr reactor during the PAA transfer and during imidization was varied over a range of 110° C. and 175° C.

After imidization a small slurry sample was collected for particle size distribution analysis. A Malvern Panalytical Mastersizer 3000 laser scattering instrument was used for determining the PSD of the polyimide wet slurry. Laser scattering measurements were carried out in de-ionized water. All measurements were carried out at room temperature and no sonication energy was used during the measurement.

The rest of the polyimide slurry was transferred to a Buchner funnel for filtration and for washing of the copolyimide particulates. The filtration rate was controlled to manage the draining of the pyridine solvent and to prevent cracks from prematurely forming in the filter cake. Just before all of the pyridine had drained from the cake, four volumes of clean acetone were added over the cake for displacement washing of the cake. After all the solvent had drained from the cake, the wet cake was left in a ventilated hood to air dry for about 1 hour, before it was transferred to a vacuum oven at 175° C. for drying overnight.

Apparent density of milled copolyimide powder was measured using a volumeter with the test method described in ASTM-D1895-17 titled “Standard Test Methods for Apparent Density, Bulk Factor, and Pourability of Plastic Materials.”

Specific surface area of the dry copolyimide powder samples was measured using the BET method as described by S. Brunauer, P. H. Emmett and E. Teller in the Journal of American Chemical Society, Volume 60, 309(1938). Before testing, samples were degassed at 120° C. for 12 hr at <100 μmHg. Nitrogen adsorption/desorption measurements were performed at 77.3 K on a Micromeritics ASAP model 2420 porosimeter. Surface area measurements utilized a five-point adsorption isotherm collected over 0.05 to 0.20 P/P₀ and analyzed using the BET method.

In order to perform tensile tests, the copolyimide powder resin was compression molded to form green tensile bars at 100,000 psi of applied pressure. The form and dimensions of the tensile bars are described in the ASTM E8 test method titled “Standard Tension Test Specimen for Powdered Metal Products-Flat Unmachined Tensile Test Bar”. Molded green bars were sintered in a nitrogen atmosphere using a series of temperature ramps that slowly heated the parts from room temperature to 405° C. over a period of 70 hrs. and were then held at 405° C. for 30 minutes before slowly cooling the parts to room temperature. Long sintering cycle (70 hrs) is not a prerequisite for demonstrating the high toughness properties of copolyimide resins. Shorter sintering cycles may also be used provided blisters or voids do not form in the parts during faster sintering cycles. Depending on the dimensions of the part being sintered, longer sintering times may also be used.

Mechanical properties of the copolymer resin were obtained by testing the tensile bars on a 30 KN Instron tester at room temperature. Tensile bars were subjected to a strain rate of 5 mm/min. Tensile measurements were made on at least 5 bars and the tensile properties that are reported are the average of tests conducted on at least 5 bars. The toughness of a sample was estimated by calculating the area under the stress strain curve using numerical integration and the average over 5 bars is reported.

The copolymer resin powder samples were also compression molded to form 8 mm diameter by 8 mm heigh green cylindrical pellets, which were then sintered at 405° C. using the 70 hr. sintering cycle. Compressive properties for the cylindrical parts were measured on a 29 kip MTS testing mechanical testing frame that was equipped with a 100 KN load cell and a laser extensometer to measure the deformation of the parts under stress. The compression speed for all tests was fixed at 2.4 mm/min which is equivalent to compression strain rate of 0.005 sec⁻¹. As in the case of tensile properties, compression properties are reported as the average obtained after tests conducted on 5 cylindrical samples.

Specific gravity of the parts was measured by the water immersion method. Parts were weighed in air and then weighed when fully immersed in a 0.05 wt. % soap solution. Soap solution is necessary to ensure the absence of tiny bubbles adhering to the test samples. Specific gravity of the parts was calculated by the following equation

$$Specific gravity = \frac{weight of part in air}{( weight of part in air - weight of part immersed in water )} .$$

Glass transition temperature (T_{g}) of the copolyimide polymers was obtained by testing rectangular sintered bars on a dynamic mechanical analyzer (TA Instruments Q800 DMA). A sample bar was clamped on dual cantilever and deformed at the center with a strain amplitude of 0.25% and at a frequency of 1 Hz. The temperature sweep for the test was from 40° C. to 425° C., at the rate of 2 C/min. The temperature corresponding to the peak for the tan δ curve is reported as the T_{g}.

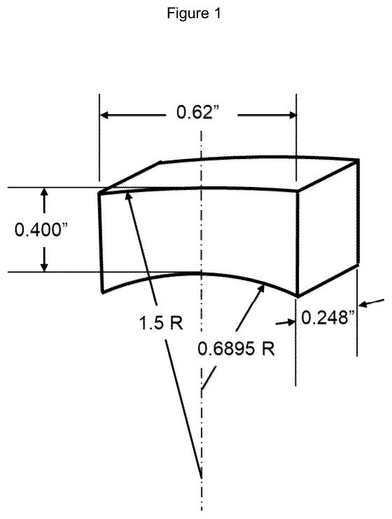

Friction and wear testing of unfilled and filled copolymers of this invention were tested on a Falex block on ring tester, manufactured by Falex Corporation, Sugar Grove, IL. ASTM test methods D 2714-94 and G77-17 describe the calibration and operation of the Falex block on ring test machine and its use in evaluating friction and wear properties of material. In its simplest form the machine consists of a rotating metal ring (also termed as counter surface) and a stationary test block loaded against a spinning ring. The test block is machined from a test sample disc whose wear and friction properties need to be evaluated. Once machined, the test block conforms to the outer surface of the counter surface metal ring. During a test, the inner curved surface of the test piece, having an area of 0.1608 in², is always in contact with the outer surface of the ring and the applied pressure on the block is constant throughout the test. The machined test block, which represents a segment of a bushing, ¼″ (6.35 mm) thick, is attached to the sample holder through a hemispherical ball to allow alignment of the machined test block to the ring as shown in FIG. 1. Load on the block is applied by dead weights, through a lever arm which has a thirty times magnification. Thus a 1 lb. dead weight amplifies to 30 pound force on the block. The metal rings used for all tests were standard “alpha” rings machined from SAE 4620 steel with a surface roughness of Rc 58-63 and 6-12 rms. A new ring is used for each block on ring test. The sample holder is connected to a load cell which measures the frictional force between the block and the ring and provides an output in pound force.

A test sample was prepared by compression molding a polyimide powder to form a 1″ diameter circular disc with a thickness of roughly 6 mm. All sample discs were molded at 80,000 psi. Each green disc was sintered using the same temperature and sintering cycle as used for tensile bars described, previously. Once sintered, each the disc was machined to form a curved block as shown in FIG. 1. After machining to the conforming configuration, the test blocks were cleaned with a solvent to remove contaminations from the sample surface and then dried at 150° C. in a vacuum oven. Each test block was weighed to the nearest 0.1 mg. Similarly, the steel ring to be used in the test was solvent cleaned to remove a rust inhibitor coating from the surface, dried and then weighed before mounting on the Falex instrument.

Friction and wear testing on the Falex Instrument is carried out in two different modes. In the constant Pressure-Velocity (PV) test mode, a fixed load is applied to the test block and the ring spins at the same preset constant velocity over the entire duration of the test. For the purpose of testing copolymers of this invention, the test duration for the constant PV test was 24 hrs. In the Pressure Velocity (PV) Limit test the load and/or the velocity are increased in every 20 minute intervals, based on a set program as shown in Table 2, until a significant increase in temperature and/or friction force is obtained. The stopping point for the PV Limit test becomes evident when the temperature and friction force rises exponentially and at this point the instrument shuts down terminating the test. The PV condition just before the termination of the test defines the PV limit of the material being tested.

TABLE 2

| Weight | Pressure | Linear speed | PV (psi |
|---|---|---|---|
| (lb.) | (psi) | (ft/min) | ft/min) |
| 3 | 170 | 294 | 50,000 |
| 5 | 340 | 294 | 100,000 |
| 8 | 510 | 294 | 150,000 |
| 11 | 680 | 294 | 200,000 |
| 14 | 850 | 294 | 250,000 |
| 16 | 1021 | 294 | 300,000 |
| 16 | 1021 | 342 | 350,000 |
| 16 | 1021 | 378 | 400,000 |
| 16 | 1021 | 439 | 450,000 |
| 16 | 1021 | 488 | 500,000 |
| 17 | 1083 | 508 | 550,000 |
| 19 | 1181 | 508 | 600,000 |
| 19 | 1181 | 550 | 650,000 |
| 19 | 1181 | 592 | 700,000 |
| 20 | 1245 | 603 | 750,000 |
| 21 | 1327 | 603 | 800,000 |
| 23 | 1409 | 603 | 850,000 |
| 24 | 1493 | 603 | 900,000 |
| 25 | 1576 | 603 | 950,000 |
| 26 | 1659 | 603 | 1,000,000 |

For both testing modes, the procedure for preparing the specimens is the same. After weighing and measuring the thickness of the test specimen (block), the test block is mounted on to the instrument with the self-aligning specimen holder. The counter surface ring is then placed onto the machine shaft. Based on the pressure value (P) required during the test, known weights are placed on the machine weight bale. Next the desired velocity (V) is set to achieve the desired PV condition. Constant PV tests are run for a total of 24 hours with a 1.5 hour “break-in” to achieve complete conformance of the block with the ring. During a test, the Falex instrument periodically monitors and reports the coefficient of friction between the surfaces of the test block and the ring counter surface. After the conclusion of a constant PV test, the test block is thoroughly dried at 150° C. for 24 hours and its weight measured to 0.1 mg accuracy. The loss in weight of the block is used to calculate wear loss based on weight. The new thickness of the block is then measured to determine an alternate measure of wear based on dimensional change. The wear based on loss in weight is reported as K_{w}. The wear base on reduction in block thickness is used to calculate wear rate (inch/hr) and wear factor based thickness change—Kₜ.

### Example 1

Polyimides obtained from 40 mol % BPDA, 40 mol % PPD, 60 mol % PMDA and 60 mol % ODA where mol % of the dianhydride components is stated based on total dianhydride basis and the mol % of the diamines is based on the total diamine basis.

Anhydrous pyridine was obtained by drying the solvent over molecular sieves. Before the start of the experiment both dianhydrides were stored in a vacuum oven at 150° C. for at least 12 hrs. 7.025 g of PPD and 19.512 g of ODA were weighed and set aside. Similarly, 18.970 g of previously dried BPDA and 21.095 g of previously dried PMDA were weighed and set aside.

562 g of anhydrous pyridine, which had been dried over molecular sieves was added to the 500 cc Chemglass® jacketed reactor. The jacket temperature of the reaction kettle was set to 45° C. and the agitator speed was set to 125 rpm. When the temperature of the solvent reached 35° C., both the diamines were added to the reactor. The temperature in the reactor was then ramped up to 50° C. When all the diamines had visibly dissolved in the pyridine heel, the two dianhydrides were simultaneously added to the kettle and any remaining dianhydride in the weighing pan was flushed using 62.4 g of anhydrous pyridine that was set aside for this purpose. After the dianhydride addition was completed, the temperature on the jacket side was increased to 70° C. The agitator speed at this time was also increased to 250 rpm.

The exotherm generated from the heat of reaction between the diamines and the dianhydrides caused the temperature in the reactor to rapidly rise to a maximum of 70° C. and then eventually stabilize. The polymerization was allowed to continue for a total time of 1 hour. At the end of the polymerization time, agitator was slowed down and the viscous PAA solution formed was drained from the bottom take off valve. A small amount of the polymer solution was set aside for the measurement of molecular weight. The number average molecular weight (Mn) and weight average molecular weight (M_{w}) for the PAA sample were measured to be 100,546 and 226,557 daltons, respectively.

The imidization process was carried out in the fed batch mode. At the start of the imidization process, about 100 ml of pyridine was initially added as a heel into the Parr vessel and heated to 114° C. The anchor impeller was also started and set to a predetermined value. Agitator RPM was set at 200. Then 597.2 g of the polyamic acid solution that had been drained from the polymerization kettle was transferred to the barrel of the ISCO pump. The exact weight of PAA solution transferred to the pump was noted. Based on this value, the exact pyridine heel required during the imidization process was calculated to be 166.7 g. Based on this calculation, 66.7 g of makeup pyridine was injected into the Parr reactor to get to the correct pyridine heel size of 166.7 g. The ISCO pump was sealed and connected to the Parr reactor using a stainless steel tubing and compression fittings. The PAA solution was transferred to the Parr reactor at a constant rate such that the entire solution transfer was completed over 90 minutes. At the end of transfer, the internal temperature of the reactor was ramped up to 145° C., over 75 minutes. After 145° C. was achieved, the contents of the vessel were held at that temperature for 30 minutes after which the reactor was cooled to room temperature.

The D50 for the polyimide particles in the slurry were measured to be 68.1 μm.

The rest of the polyimide slurry was filtered and the resulting filter cake was washed with acetone and then dried at 175° C. under vacuum. The dried polyimide polymer was milled in a lab Wiley mill while being screened through a 30 mesh screen.

The dried polymer was milled and characterized for apparent density (AD) and specific surface area (SA). The AD and SA of the copolyimide polymer were 0.159 and 112.4 m²/g.

The copolymer resin was compression molded into tensile bars and cylindrical pellets for measurement of compressive properties. The green parts were sintered at 405° C. The specific gravity of the sintered parts was 1.420. The T_{g} from the tan δ curve was 371.4° C.

The average tensile strength and % elongation measured for 5 tensile bars was 18388 psi and 14.7%, respectively. The stress strain curves were used to obtain the average toughness of the copolyimide resin to be 2.27 Ksi. The average compressive strength was measured to be 750 MPa and the average deformation at break was 62.5%.

### Examples 2-8

Higher specific gravity, low apparent density and higher toughness polyimide compositions containing BPDA, PMDA, PPD and ODA. In these examples mol % of BPDA on total dianhydride basis was kept the same as mol % of PPD on total diamine basis.

Copolyimide resin compositions illustrated in Examples 2-8 were synthesized using the same process as outlined in Example 1. Table 3 shows the polymer composition, the amount of each monomer used, and the solvent used during polymerization for Examples 2-8. Table 4 shows the conditions for the imidization step for the synthesis of the copolyimide polymers of this invention and the attributes of the polymer powders obtained after drying. Table 5 shows the polymer part properties after sintering.

TABLE 3

| | | | | | | | | | Wt. of |
|---|---|---|---|---|---|---|---|---|---|
| | | | | | | | | | pyridine |
| | | | | | | | | | for |
| | | PPD | | ODA | Wt. of | Wt. of | Wt. of | Wt. of | poly- |
| | BPDA | mol | PMDA | mol | BPDA | PMDA | PPD | ODA | merization |
| | mol % | % | mol % | % | (g) | (g) | (g) | (g) | (g) |
| Example | 20 | 20 | 80 | 80 | 9.485 | 28.126 | 3.512 | 26.018 | 629.2 |
| 2 | | | | | | | | | |
| Example | 50 | 50 | 50 | 50 | 23.713 | 17.579 | 8.781 | 16.260 | 621.6 |
| 3 | | | | | | | | | |
| Example | 60 | 60 | 40 | 40 | 28.455 | 14.063 | 10.538 | 13.008 | 619.1 |
| 4 | | | | | | | | | |
| Example | 80 | 80 | 20 | 20 | 37.940 | 7.032 | 14.050 | 6.504 | 614.1 |
| 5 | | | | | | | | | |
| Example | 30 | 30 | 70 | 70 | 14.228 | 24.610 | 5.269 | 22.765 | 626.7 |
| 6 | | | | | | | | | |
| Example | 35 | 35 | 65 | 65 | 16.599 | 22.853 | 6.132 | 21.086 | 624.8 |
| 7 | | | | | | | | | |
| Example | 40 | 40 | 60 | 60 | 20.006 | 22.246 | 7.390 | 20.527 | 657.6 |
| 8 | | | | | | | | | |

TABLE 4

| | Wt. of | Wt. of | | | | | |
|---|---|---|---|---|---|---|---|
| | PAA | pyridine | | | Particle | | Specific |
| | transferred | in | | | size | Apparent | surface |
| | to imidizer | imidizer | | | D50 | density | area |
| | (g) | heel (g) | Mₙ | M_{w} | (mm) | (g/cc) | (m²/g) |
| Example 2 | 610.7 | 170.5 | 100,546 | 226,557 | 97 | 0.164 | 107.7 |
| Example 3 | 620.9 | 173.4 | 98,826 | 207,130 | 91.6 | 0.140 | 118.2 |
| Example 4 | 626.3 | 174.9 | 90,031 | 192,864 | 80.3 | 0.144 | |
| Example 5 | 546.0 | 152.5 | 93,639 | 193,396 | 132 | 0.159 | |
| Example 6 | 607.1 | 169.5 | 78,852 | 170,916 | 78.2 | 0.156 | 117 |
| Example 7 | 592.8 | 165.5 | 65,862 | 150,673 | 81.7 | 0.159 | |
| Example 8 | 629.1 | 175.7 | | | 79.8 | 0.184 | |

TABLE 5

| | | Peak | | | | | |
|---|---|---|---|---|---|---|---|
| | | Tensile | Elongation | Tensile | Compressive | Compressive | |
| | Specific | stress | at break | toughness | strength | strain at | T_{g} |
| | gravity | (psi) | (%) | (Ksi) | (Mpa) | break (%) | (° C.) |
| Example | 1.413 | 17251 | 21.9 | 2.81 | 819 | 70.7 | 382.0 |
| 2 | | | | | | | |
| Example | 1.425 | 20398 | 15.2 | 2.61 | 750 | 59.7 | 352.7 |
| 3 | | | | | | | |
| Example | 1.434 | 21500 | 14.0 | 2.56 | 647 | 54.2 | 337.0 |
| 4 | | | | | | | |
| Example | 1.433 | 21852 | 5.7 | 0.87 | 602 | 51.2 | 332.7 |
| 5 | | | | | | | |
| Example | 1.427 | 18700 | 17.7 | 2.80 | 707 | 66.1 | |
| 6 | | | | | | | |
| Example | 1.423 | 17300 | 18.79 | 2.72 | 715 | 62.3 | 376 |
| 7 | | | | | | | |
| Example | 1.416 | 17800 | 20.1 | 3.28 | 731 | 65.8 | 371 |
| 8 | | | | | | | |

### Comparative Examples 1-2

Homopolymers derived from BPDA and PPD and PMDA and ODA, respectively, exhibiting poor toughness than the polyimides of this invention exemplified by Examples 1-8.

Imidized homopolymer of BPDA and PPD was obtained by polymerization and imidization reactions in a manner very similar to described in Example 1, except the homopolymerization and subsequent imidization of BPDA-PPD was carried out in a 10:1 ratio (by weight) of pyridine to NMP. A modification to the solvent was necessary as the polyamic acid homopolymer of BPDA and PPD is immiscible in pyridine and small amounts NMP are necessary to ensure that the polyamic acid stays in solution. Before the start of the polymerization, 18.776 g of PPD was dissolved in 624 g of Pyridine-NMP mixture and then reacted at 50° C. with 50.574 g of BPDA. After the polymerization was completed, 576 g of the resulting polyamic acid (PAA) homopolymer solution was slowly transferred to a 247 g of 10:1 mixture of pyridine and NMP following the transfer procedure in Example 1. During the PAA transfer, the temperature of the solvent was held at 114° C. After the imidized polymer had precipitated during this imidization process, the temperature of the reactor was increased to 145° C., to maximize the precipitation of the polymer and to further enhance the extent of imidization of the precipitated polymer. The D50 of the particle distribution was measured to be 76.6 μm. The polyimide solvent slurry was cooled to 60° C. and then filtered. The filter cake was washed with acetone and then dried in a vacuum oven at 180° C., just as described in Example 1. The dried polymer was milled through a 30 mesh screen before further use. The AD of the powder was measured to be 0.170 g/cc. Polymer powder was compression molded to form test parts for tensile testing. Toughness of the homopolymer under tension was obtained from the stress strain curves. The properties of finished parts of BPDA PPD homopolymer are shown in Table 6. BPDA-PPD homopolymer exhibits extremely low elongation and very low toughness.

TABLE 6

| | | Peak | | |
|---|---|---|---|---|
| | | Tensile | Elongation | Tensile |
| | Specific | stress | at break | toughness |
| | gravity | (psi) | (%) | (Ksi) |
| Comparative | 1.439 | 19000 | 2.38 | 0.26 |
| Example 1 | | | | |

Imidized homopolymer of PMDA and ODA was obtained by polymerizing 30.537 g of PMDA with 28.132 g of ODA in 362 g of pure pyridine solvent. The PAA homopolymer formed in solution was imidized by slowly transferring 290 g of it into 86 g of pyridine at 114° C., after which the entire solutions was heated to 145° C. to precipitate and form the PMDA-ODA polyimide homopolymer. The homopolymer was filtered, washed and vacuum dried as described in Example 1. The dried polymer was milled. The AD was measured to be 0.177 g/cc. Polymer powder was compression molded to form test parts for both tensile testing. Toughness of the homopolymer under tension was obtained from the stress strain curves. The properties of the finished parts of homopolymer PMDA ODA are shown in Table 7. PMDA-ODA homopolymer exhibits higher elongation and higher toughness than BPDA-PPD homopolymer, but still much lower toughness than the copolymers shown in Examples 1-8.

TABLE 7

| | | Peak | | |
|---|---|---|---|---|
| | | Tensile | Elongation | Tensile |
| | Specific | stress | at break | toughness |
| | gravity | (psi) | (%) | (Ksi) |
| Comparative | 1.388 | 12560 | 7.9 | 0.663 |
| Example 2 | | | | |

### Comparative Examples 3-6

Polyimide blends created by blending polymer of BPDA and PPD with the polymer of PMDA and ODA in varying weight ratios to compare the properties of the blended polymer compositions with those of polyimide compositions comprising similar amounts of BPDA, PMDA, PPD and ODA but in the polymer backbone. The blended polymers in these examples show inferior strength, elongation and toughness compared to the copolyimide compositions having the same monomer composition.

Imidized homopolymer of BPDA-PPD was synthesized in exactly the same manner as described in Comparative Example 1. After the imidization step was completed, the polymer slurry in pyridine-NMP mixture was set aside for further processing in the ensuing examples.

Imidized homopolymer of PMDA and ODA, is manufactured by E. I. duPont & Nemours company and finished parts and shapes fabricated from this polymer are sold under the trade name of Vespel® SP-01. A SP-01 polyimide slurry sample was collected from the Vespel® manufacturing plant and further processed in the ensuing examples. The D50 of SP-01 slurry was measured to be 27.0 μm.

### Comparative Example 3

BPDA-PPD homopolymer slurry in pyridine comprising 10 g of solid BPDA-PPD homopolymer and PMDA-ODA homopolymer slurry in pyridine comprising 40 g of PMDA-ODA were weighed into a round bottom flask and vigorously mixed with an overhead agitator assembly for 15 minutes. The blended polymer slurry was filtered and the wet cake washed with excess acetone. The acetone laden cake was dried in a vacuum oven at 180° C., for 16 hrs and the dried polymer was milled through 30 mesh screen. Because the resulting polymer blend was obtained by mixing the two homopolymer components in slurry form, it is reasonable to assume that the individual particles that make up the two homopolymer slurries were intimately dispersed leading to a well mixed polymer system. In the resulting polymer blend, the mol % of BPDA on total dianhydride basis should be 20% and the mol % of PPD on the total diamine basis should be 20%. The blended polymer powder was compression molded into tensile bars, sintered and tested for properties in the same manner as described in Example 1.

### Comparative Example 4

BPDA-PPD homopolymer slurry comprising 20 g of solid BPDA-PPD homopolymer and PMDA-ODA homopolymer slurry comprising 30 g of PMDA-ODA homopolymer were blended together and the resulting slurry was processed to form dry powder and test parts as described in Comparative Example 3.

### Comparative Example 5

BPDA-PPD homopolymer slurry comprising 30 g of solid BPDA-PPD homopolymer and PMDA-ODA homopolymer slurry comprising 20 g of PMDA-ODA were blended together and the resulting slurry was processed to form dry powder and test parts as described in Comparative Example 3.

### Comparative Example 6

BPDA-PPD homopolymer slurry comprising 40 g of solid BPDA-PPD homopolymer and PMDA-ODA homopolymer slurry comprising 10 g of PMDA-ODA were blended together and the resulting slurry was processed to form dry powder and test parts as described in Comparative Example 3.

The final properties of the blended polymer compositions of Comparative Examples 3-6 are shown in Table 8.

TABLE 8

| | | | | | Tensile | | |
|---|---|---|---|---|---|---|---|
| | mol % | mol % | AD | Specific | Strength | % | Toughness |
| | BPDA | PPD | (g/cc) | gravity | (psi) | Elongation | (Ksi) |
| Comparative | 20 | 20 | 0.184 | 1.398 | 12440 | 5.9 | 0.50 |
| example 3 | | | | | | | |
| Comparative | 40 | 40 | 0.193 | 1.400 | 12300 | 4.58 | 0.35 |
| example 4 | | | | | | | |
| Comparative | 60 | 60 | 0.206 | 1.409 | 14000 | 3.43 | 0.30 |
| example 5 | | | | | | | |
| Comparative | 80 | 80 | 0.186 | 1.413 | 15700 | 3.11 | 0.30 |
| example 6 | | | | | | | |

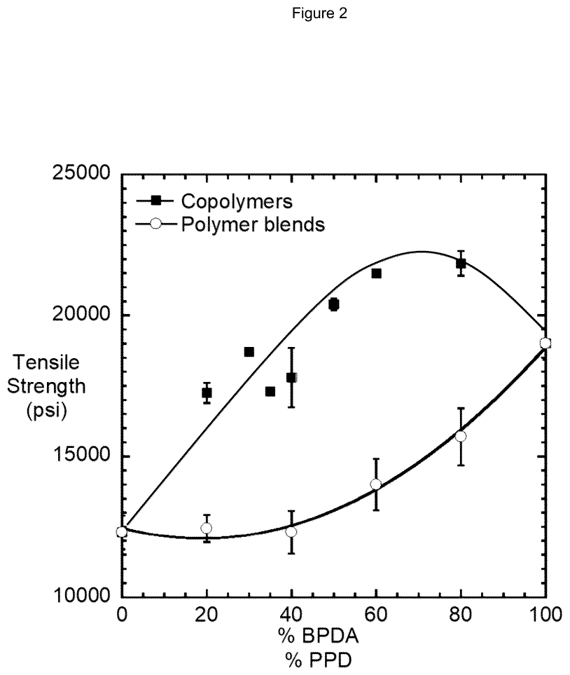

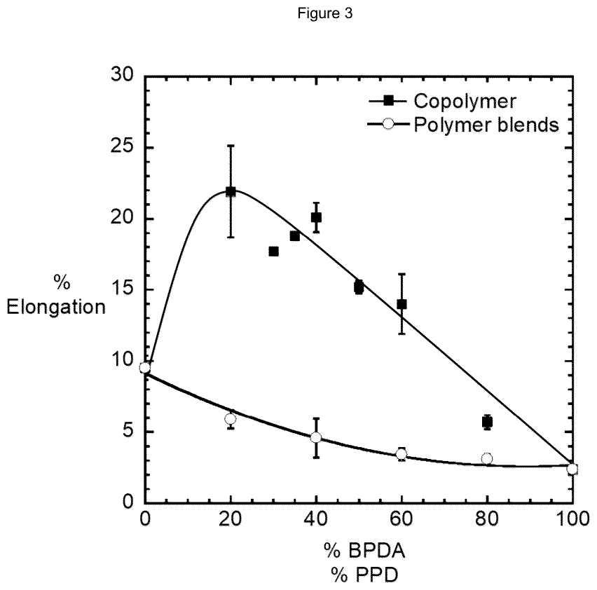

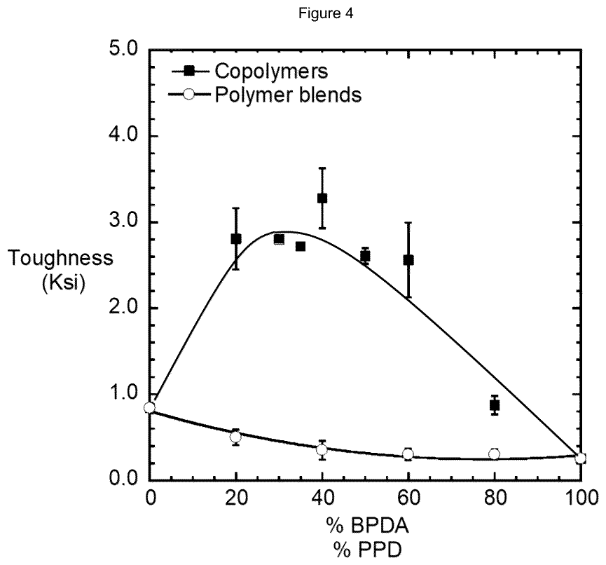

Results from Comparative Examples 3-6 are compared in graphical form with results from Examples 1-8 in FIGS. 2, 3 and 4, where the tensile strength, % elongation at break and tensile toughness of copolyimides of this invention are compared to those of blended polyimides when plotted against the BPDA and PPD content in the polymers. These examples and resulting figures show that the copolyimides of this invention exhibit significantly better performance over blended homopolymers that have the same BPDA, PPD, PMDA and ODA content.

### Examples 9-17

Additional higher specific gravity, low apparent density and higher toughness copolyimide compositions containing BPDA, PMDA, PPD and ODA. In Examples 1-8 of this invention, the mol % of BPDA on total dianhydride basis and mol % of PPD on total diamine basis were kept equal. In Examples 9-17, mol % of BPDA is not equal to the mol % of PPD and yet the tensile properties and toughness are similar to those observed in Examples 1-8, thus showing that the contents of BPDA and PPD in the copolymer do not have to be the same to create high toughness copolymer compositions.

Copolyimide resin compositions illustrated in Examples 9-17 were synthesized using the same process as outlined in Example 1 except during the imidization of the PAA transfer, the temperature ranged between 110° C. and 150° C. Table 9 shows the polymer composition, the amount of each monomer used, and the solvent used during polymerization for Examples 9-17. Table 10 shows the conditions for the imidization step for the synthesis of the copolyimide polymers of this invention and the attributes of the polymer powders obtained after drying. Table 11 shows the polymer part properties after sintering.

TABLE 9

| | | | | | | | Wt. | | Wt. of pyridine |
|---|---|---|---|---|---|---|---|---|---|
| | | PPD | | ODA | Wt. of | Wt. of | of | Wt. of | for |
| | BPDA | mol | PMDA | mol | BPDA | PMDA | PPD | ODA | polymerization |
| | mol % | % | mol % | % | (g) | (g) | (g) | (g) | (g) |
| Example | 60 | 40 | 40 | 60 | 28.46 | 14.063 | 7.025 | 19.512 | 647.1 |
| 9 | | | | | | | | | |
| Example | 30 | 35 | 70 | 65 | 14.23 | 24.61 | 6.132 | 21.086 | 619.0 |
| 10 | | | | | | | | | |
| Example | 30 | 40 | 70 | 60 | 14.48 | 25.038 | 7.147 | 19.851 | 623.3 |
| 11 | | | | | | | | | |
| Example | 35 | 30 | 65 | 70 | 16.6 | 22.853 | 5.256 | 22.708 | 631.8 |
| 12 | | | | | | | | | |
| Example | 35 | 40 | 65 | 60 | 16.6 | 22.853 | 7.008 | 19.464 | 617.8 |
| 13 | | | | | | | | | |
| Example | 40 | 30 | 60 | 70 | 18.97 | 21.095 | 5.256 | 22.708 | 637.5 |
| 14 | | | | | | | | | |
| Example | 40 | 35 | 60 | 65 | 18.97 | 21.095 | 6.132 | 21.086 | 630.5 |
| 15 | | | | | | | | | |
| Example | 70 | 30 | 30 | 70 | 30.82 | 9.792 | 4.884 | 21.104 | 624.1 |
| 16 | | | | | | | | | |
| Example | 50 | 20 | 50 | 80 | 22.31 | 16.542 | 3.3 | 24.446 | 624.1 |
| 17 | | | | | | | | | |

TABLE 10

| | Wt. of | Wt. of | | | | | |
|---|---|---|---|---|---|---|---|
| | PAA | pyridine | | | Particle | | Specific |
| | transferred | in | | | size | Apparent | surface |
| | to imidizer | imidizer | | | D50 | density | area |
| | (g) | heel (g) | Mₙ | M_{w} | (mm) | (g/cc) | (m²/g) |
| Example 9 | 580.3 | 162.1 | 86,403 | 179,409 | 66.1 | 0.190 | 73.9 |
| Example 10 | 583.5 | 162.9 | 105,837 | 231,263 | 83.1 | 0.157 | |
| Example 11 | 624.2 | 174.3 | | | 104 | 0.156 | |
| Example 12 | 613.9 | 171.4 | 57,897 | 115,318 | 82.7 | 0.180 | |
| Example 13 | 591.2 | 165.1 | | | 97.1 | 0.159 | |
| Example 14 | 635.8 | 177.6 | | | 83.3 | 0.226 | |
| Example 15 | 593.4 | 165.7 | 62,570 | 129,650 | 68.4 | 0.171 | |
| Example 16 | 587.1 | 164.0 | | | | 0.168 | 96.0 |
| Example 17 | 587.1 | 164.0 | | | | 0.195 | 106.8 |

TABLE 11

| | | Peak | | | | | |
|---|---|---|---|---|---|---|---|
| | | Tensile | Elongation | Tensile | Compressive | Compressive | |
| | Specific | stress | at break | toughness | strength | strain at | T_{g} |
| | gravity | (psi) | (%) | (Ksi) | (Mpa) | break (%) | (º C.) |
| Example | 1.416 | 19100 | 15.5⁺ | 2.46⁺ | | | 325.5 |
| 9 | | | | | | | |
| Example | 1.421 | 17200 | 18.25 | 2.66 | 693 | 64.5 | 385 |
| 10 | | | | | | | |
| Example | 1.425 | 16500 | 14.60 | 1.97 | 670 | 66.0 | 385 |
| 11 | | | | | | | |
| Example | 1.423 | 16600 | 16.86 | 2.42 | 706 | 64.5 | 371.5 |
| 12 | | | | | | | |
| Example | 1.413 | 17700 | 16.90 | 2.55 | 669 | 62.1 | 397 |
| 13 | | | | | | | |
| Example | 1.423 | 17300 | 16.82 | 2.42 | 773 | 66.8 | 356.7 |
| 14 | | | | | | | |
| Example | | 17900 | 20.09 | 3.16 | 785 | 64.3 | 361.8 |
| 15 | | | | | | | |
| Example | 1.414 | 18200 | 19.20 | 3.25 | | | |
| 16 | | | | | | | |
| Example | 1.386 | 17100 | 19.00 | 2.80 | | | |
| 17 | | | | | | | |

⁺Sample bars did not break under tension and the test was concluded before test sample failure.

### Comparative Examples 7-13

These examples show that when the mol % of BPDA based on total dianhydride content in the copolymer composition is significantly different from mol % of PPD based on the total diamine content, the copolyimides exhibit high AD, low specific gravity and low toughness in the final sintered parts.

Copolyimide resin compositions illustrated in comparative examples 7-13 were also synthesized using the same process as outlined in Example 1. Table 12 shows the polymer composition, the amount of each monomer used, and the solvent used during polymerization and imidization step for the synthesis of the copolyimide polymers of this invention. Table 13 shows the conditions for the imidization step for the synthesis of the copolyimide polymers of this invention and the attributes of the polymer powders obtained after drying. Table 14 shows the polymer part properties after sintering.

TABLE 12

| | | | | | | | | | Wt of pyridine |
|---|---|---|---|---|---|---|---|---|---|
| | | | | ODA | wt. of | wt. of | Wt. of | Wt. of | for |
| | BPDA | PPD | PMDA | mol | BPDA | PMDA | PPD | ODA | polymerization |
| | mol % | mol % | mol % | % | (g) | (g) | (g) | (g) | (g) |
| Comparative | 20 | 50 | 80 | 50 | 9.485 | 28.126 | 8.781 | 16.26 | 768.6 |
| Example 7 | | | | | | | | | |
| Comparative | 50 | 80 | 50 | 20 | 23.713 | 17.579 | 14.05 | 6.504 | 579.6 |
| Example 8 | | | | | | | | | |
| Comparative | 50 | 0 | 50 | 100 | 23.713 | 17.579 | 0 | 32.521 | 691.7 |
| Example 9 | | | | | | | | | |
| Comparative | 80 | 20 | 20 | 80 | 37.940 | 7.032 | 3.513 | 26.017 | 698.2 |
| Example 10 | | | | | | | | | |
| Comparative | 80 | 50 | 20 | 50 | 37.940 | 7.032 | 8.781 | 16.260 | 656.1 |
| Example 11 | | | | | | | | | |
| Comparative | 70 | 30 | 30 | 70 | 30.822 | 9.792 | 4.884 | 21.104 | 624.1 |
| Example 12 | | | | | | | | | |
| Comparative | 50 | 20 | 50 | 80 | 22.314 | 16.542 | 3.300 | 24.446 | 624.1 |
| Example 13 | | | | | | | | | |

TABLE 13

| | Wt. of | Wt. of | | | | | |
|---|---|---|---|---|---|---|---|
| | PAA | pyridine | | | Particle | | Specific |
| | transferred | in | | | size | Apparent | surface |
| | to imidizer | imidizer | | | D50 | density | area |
| | (g) | heel (g) | Mₙ | M_{w} | (mm) | (g/cc) | (m²/g) |
| Comparative | 597.2 | 166.8 | 41,373 | 83,194 | 155 | 0.1847 | |
| Example 7 | | | | | | | |
| Comparative | 521.9 | 145.7 | 85,030 | 170,952 | 25.8 | 0.2326 | |
| Example 8 | | | | | | | |
| Comparative | 713.3 | 199.2 | 37,579 | 78,836 | 28.1 | extremely | |
| Example 9 | | | | | | dense | |
| Comparative | 493.7 | 137.9 | 93,459 | 205,139 | 21.9 | 0.6227 | 0.9 |
| Example 10 | | | | | | | |
| Comparative | 612.9 | 171.2 | 40,662 | 92,296 | 47.8 | 0.5339 | |
| Example 11 | | | | | | | |
| Comparative | 587.1 | 164 | 107083 | 233,437 | 47.9 | 0.332 | 81.2 |
| Example 12 | | | | | | | |
| Comparative | 587.1 | 164 | 142634 | 289,141 | 46.9 | 0.310 | 53.8 |
| Example 13 | | | | | | | |

TABLE 14

| | | Peak | | |
|---|---|---|---|---|
| | | Tensile | Elongation | Tensile |
| | Specific | stress | at break | toughness |
| | gravity | (psi) | (%) | (Ksi) |
| Comparative | 1.383 | 12700 | 3.85 | 0.303 |
| Example 7 | | | | |
| Comparative | 1.394 | 16800 | 4.14 | 0.441 |
| Example 8 | | | | |
| Comparative | Dried polymer as hard as concrete. Could | | | |
| Example 9 | not be milled to a powder. | | | |
| Comparative | Sintered bars too brittle and weak to test for | | | |
| Example 10 | stress strain. They broke as they were | | | |
| | mounted on the Instron. | | | |
| Comparative | 1.361 | 3690 | 1.39 | 0.03 |
| Example 11 | | | | |
| Comparative | 1.359 | 14200 | 3.99 | 0.34 |
| Example 12 | | | | |
| Comparative | 1.323 | 11500 | 4.2 | 0.30 |
| Example 13 | | | | |

All the comparative examples presented here exhibit significantly poorer properties than copolymers of this invention demonstrated in Examples 1-17. In the current comparative examples either the tensile properties and toughness are poor, or the polymer attributes do not allow for fabrication of adequate parts for testing. Polymer powders formed in Comparative Examples 9-13 are dense as seen by high AD. Dense powders yield parts with low specific gravity, low tensile strength, low % elongation and low polymer toughness. Comparative Example 9 uses only 3 monomers (BPDA, PMDA and ODA) in the composition. These examples demonstrate that all four monomers—BPDA, PMDA, PPD and ODA—are needed to form polymers of low powder density and high toughness. Copolymers of Comparative Examples 10 and 11 were synthesized from all 4 monomers and they exhibit adequately low apparent density (≤0.25 Ksi) but yet they show low strength, low elongation and very low toughness. In both these poorly performing copolymer compositions, mol % of PPD is significantly greater than mol % of BPDA. Therefore, the examples demonstrate that for higher toughness copolymer compositions, mol % of BPDA needs to be ≥(mol % of PPD+0.2).

### Example 18

Copolyimide composition with 60 mol % BPDA, 60 mol % PPD, 40 mol % PMDA and 40 mol % ODA containing 9% by weight graphite as a filler.

Polyamic acid of copolyimide of this example was synthesized in the lab using a process very similar to described in Example 1. 10.54 g of PPD and 13.01 g of ODA were dissolved in 600 g of anhydrous pyridine at 35° C. The diamine solution was heated to 50° C. at which point 28.46 g of BPDA and 14.06 g of PMDA were simultaneously added to the reaction vessel to initiate the polymerization reaction. 19.1 g of addition pyridine was used to wash down into the polymerization reactor any remains of dianhydrides in the weighing pan.

After 1 hour of reaction time, the Mₙ and M_{w} for the polymer were measured to be 90,000 dalton and 186,000 dalton, respectively.

168.8 g of anhydrous pyridine was added to the clean high pressure Parr reactor. To this solvent heel, 5.96 g of natural graphite, grade 200-09 sold by Southern Graphite was added and dispersed with the help of the anchor agitator turning at 200 rpm. The reactor was purged with nitrogen and the graphite-pyridine slurry was heated to 114° C. At about the same time, 548.1 g of the PAA solution synthesized above was transferred to the ISCO syringe pump and heated to 70° C. Once the temperature of PAA solution in the pump was stable, transfer of the PAA solution to the Parr reactor was initiated. Temperature of the imidization reaction was held constant at 114° C. during the entire PAA transfer. All of the PAA in the ISCO pump was transferred in 90 minutes. At the end of the transfer, the PAA feed line from the pump was purged into the imidization reactor with 29.1 g of pyridine. As in Example 1, at the end of the PAA transfer the contents of the imidizer were heated to 145° C. over 75 minutes after which the reactor was held at 145° C. for another 30 minutes. After this hold time, imidization process was considered complete and the contents of the reactor were cooled to room temperature.

The D50 for the particle size distribution of the particles in the reaction slurry was measured to be 57.9 μm. The graphite containing copolyimide slurry was filtered, the filter cake washed with acetone and then dried in a heated vacuum oven overnight to obtain a copolyimide resin containing 9 wt. % of graphite.

The polymer powder was compression molded at room temperature to form green tensile bars which were sintered at 405° C. just as described in Example 1. Tensile properties of the sintered bars were measured in the same manner also as described in Example 1.

Table 15 shows the tensile strength, % elongation at break and the measured toughness of the graphite containing copolyimide. It is well known by those skilled in the art, that addition of solid fillers to any polymer will reduce its toughness. But even though the copolyimide of this example contains 9% graphite filler and its toughness has dropped from that of the unfilled composition taught by Example 4, the filled copolymer still shows higher toughness than the unfilled homopolymers of BPDA-PPD and PMDA-ODA.

TABLE 15

| Tensile | % | |
|---|---|---|
| strength | Elongation | Toughness |
| (psi) | at break | (Ksi) |
| 19,400 | 9.94 | 1.50 |

### Example 19

Copolyimide containing polyamic acid containing 60 mol % BPDA, 60 mol % PPD, 40 mol % PMDA and 40 mol % ODA was synthesized just as described in Example 17. Imidization step was also very similar to that described in Example 17, except for this example 0.5 g of Polyfil DL Kaolinite (supplied by KaMin, LLC) was added along with the 5.3 g of natural graphite to an anhydrous pyridine heel of 169.9 g in the high pressure Parr reactor. For this reaction, 548.2 g of copolyimide PAA solution was transferred into the imidization reactor over 90 minute duration. The final composition of the fillers in the copolyimide resin was 1 wt. % Kaolinite and 9 wt. % graphite.

Tensile bars from the filled copolyimide resin were fabricated and tested as described in Example 1. The tensile strength, % elongation and toughness of the filled copolyimide resin are shown in Table 16.

Here again, the filled copolymer of this example exhibits higher toughness than the unfilled homopolymers of BPDA-PPD and PMDA-ODA.

TABLE 16

| Tensile | % | |
|---|---|---|
| strength | Elongation | Toughness |
| (psi) | at break | (Ksi) |
| 19,170 | 9.12 | 1.38 |

### Example 20

Copolyimide composition with 60 mol % BPDA, 60 mol % PPD, 40 mol % PMDA and 40 mol % ODA and containing 10% by weight graphite as filler.

A copolyimide polyamic acid comprising 60 mol % BPDA, 60 mol % PPD, 40 mol % PMDA and 40 mol % ODA was polymerized in the same manner as described in Example 1. 7.03 g of PPD and 19.51 g of ODA were reacted with 18.97 g of BPDA and 21.09 g of PMDA in 624.1 g of anhydrous pyridine.

Imidization process in the presence natural graphite was carried out in the same manner as described in Example 17. 5.9 g of natural graphite was dispersed in 168.5 g of anhydrous pyridine heel. 552.6 g of copolyimide polyamic acid was added to the imidization reaction followed by 29 g of clean pyridine. After the imidization reaction was completed, the slurry was filtered, the cake was washed with acetone and then dried. Tensile bars were fabricated from the filled resin and then tested for tensile properties.

The tensile strength of the filled copolyimide resin was 17,480 psi and the % elongation at break was 12.76%.

### Examples 21-25

The current examples demonstrate low friction and low wear performance of graphite and kaolinite filled copolymers of this invention.

Copolyimide compositions with varying amounts of BPDA, PPD, PMDA and ODA were polymerized using the same process described in Example 1. The copolymer polyamic acid solutions thus produced, were converted to graphite and Kaolinite filled polyimide powders and parts using the process described in Example 18. Two different graphite types were used for these examples. First is a natural graphite 200-09 sold by Southwestern Graphite and the second is a synthetic graphite Asbury 4767 sold by Asbury Carbons.

The composition of the copolymers created are shown in Table 17 and the tensile properties of these polymers are shown in Table 18.

TABLE 17

| | BPDA | PPD | PMDA | ODA | Graphite | Kaolinite | Graphite |
|---|---|---|---|---|---|---|---|
| | (mol %) | (mol %) | (mol %) | (mol %) | (wt %) | (wt %) | type |
| Example 21 | 40 | 50 | 5 | 3 | 5 | 3 | Natural |
| Example 22 | 60 | 40 | 5 | 3 | 5 | 3 | Synthetic |
| Example 23 | 60 | 60 | 10 | 3 | 10 | 3 | Synthetic |
| Example 24 | 40 | 40 | 15 | 3 | 15 | 3 | Synthetic |

TABLE 18

| | | | Tensile | |
|---|---|---|---|---|
| | AD | Specific | Strength | % |
| | (g/cc) | gravity | (psi) | Elongation |
| Example 21 | 0.157 | 1.465 | 17400 | 7.5 |
| Example 22 | 0.170 | 1.485 | 18998 | 17.5 |
| Example 23 | 0.164 | 1.522 | 19579 | 6.9 |
| Example 24 | 0.152 | 1.540 | 16915 | 5.8 |

The copolymer powders of Examples 21-25 were compression molded at 80,000 psi to form 1″ diameter discs having a thickness between 6 and 6.5 mm. Three discs were formed from each composition. The green discs were sintered using the same sintering cycle and temperature as used for all of the tensile bars in previous examples. After sintering, the discs were machined to form test blocks to fit snugly with the Falex tester steel rings. The machined blocks were mounted onto the sample holder on the Falex tester and then tested at different PV conditions as described in previous section. For each composition multiple tests were performed. One test was performed at a constant PV of 100,000 psi ft/min for 24 hrs, a second test was performed at a PV of 300,000 psi ft/min and another test at an ever increasing PV conditions (PV Limit test) until the sample failed or the temperature increased exponentially due to frictional heating to terminate the test. At the end of the constant PV tests, dimensional wear, weight based wear factor, coefficient of friction and the steady state ambient temperature due to frictional heat dissipation were recorded. The friction and wear performance of the filled copolymers at 100,000 psi ft/min is shown in Table 19 and the friction and wear performance at the higher PV conditions of 300,000 psi ft/min is shown in Table 20. Also shown in the Table 18 are the PV limiting conditions at which the PV limit test is terminated due to exponential rise in temperature due to frictional heating.

TABLE 19

| | PV = 100,000 psi. ft.min | | | |
|---|---|---|---|---|
| | | Wear | Coeff. | |
| | Wear | Factor K_{w} | of | Temperature |
| | (inch) | (10⁻¹⁰) | Friction | (° C.) |
| Example 21 | 0.0051 | 22.7 | 0.064 | 53 |
| Example 22 | 0.003 | 13.3 | 0.057 | 52 |
| Example 23 | 0.0026 | 11.6 | 0.057 | 51 |
| Example 24 | 0.0028 | 12.4 | 0.048 | 48 |

TABLE 20

| | PV = 300,000 psi. ft/min | | | | |
|---|---|---|---|---|---|
| | | Wear | Coeff. | | PV Limit |
| | Wear | Factor K_{w} | of | Temperature | (psi |
| | (inch) | (10⁻¹⁰) | Friction | (° C.) | ft/min) |
| Example 21 | 0.013 | 19.3 | 0.091 | 65 | 950,000 |
| Example 22 | 0.0093 | 13.7 | 0.071 | 58 | 600,000 |
| Example 23 | 0.0085 | 13 | 0.048 | 66 | 950,000 |
| Example 24 | 0.0089 | 13.2 | 0.049 | 67 | 950,000 |

### Comparative Examples 14-15

E. I. duPont & Nemours Company manufactures a graphite filled homopolymer of PMDA-ODA under the trade name of Vespel® SP-21. The average tensile strength and % elongation of this polymer grade are 10,500 psi and 7.5%, respectively.

DuPont also manufactures a graphite filled polymer derived from BPDA and PPD and is sold under the trade name of Vespel® SCP-50094. The average tensile strength and % elongation for this grade are 20,000 psi and 4.0%, respectively.

Powder forms of SP-21 polymer and SCP-50094 polymer were compression molded at 80,000 psi to form multiple 1″ diameter circular discs, 6 mm in thickness. The discs were machined into friction and wear test blocks for the Falex block on ring tester. Both grades of polymer were tested for friction and wear at 100,000 psi ft/min, at 300,000 psi ft/min and for the PV limit test.

The friction and wear performance at 100,000 psi ft/min for both SP-21 and SCP-50094 are shown in Table 21 and the friction and wear performance at 300,000 psi ft/min with PV limits for both polymers are shown in Table 22. The filled copolymers of this invention as exemplified by Examples 21-25 exceed the performance of both SP-21 with respect to tensile properties as well as friction and wear performance.

TABLE 21

| | | PV = 100,000 psi. ft/min | | | |
|---|---|---|---|---|---|
| | | | Wear | Coeff. | Temper- |
| | Polymer | Wear | Factor K_{w} | of | ature |
| | grade | (inch) | (10⁻¹⁰) | Friction | (deg C.) |
| Comparative | SP-21 | 0.013 | 54.6 | 0.17 | 73 |
| Example 14 | | | | | |
| Comparative | SCP-50094 | 0.0041 | 17.1 | 0.056 | 57 |
| Example 15 | | | | | |

TABLE 22

| | | PV = 300,000 psi. ft/min | | | | |
|---|---|---|---|---|---|---|
| | | | Wear | Coeff. | | |
| | Polymer | Wear | Factor | of | Temperature | PV Limit |
| | grade | (inch) | K_{w}(10⁻¹⁰) | Friction | (deg C.) | (psi ft/min) |
| Comparative | SP-21 | Cannot be tested over 24 hrs. Sample fails | | | | 300,000 |
| Example 14 | | at 300,000 psi ft/min | | | | |
| Comparative | SCP- | 0.044 | 60.6 | 0.168 | 107 | 600,000 |
| Example 15 | 50094 | | | | | |

That which is claimed is:

1. A polyimide composition, comprising:
particles of a polyimide polymer derived from (i) ODA, (ii) PMDA, (iii) PPD, and (iv) BPDA monomers,
wherein, when the polyimide composition consists of the particles of the polyimide polymer, the polyimide composition has an apparent density of ≤0.25 grams per cubic centimeter.

2. The polyimide composition of claim 1, wherein a part made from the polyimide composition consisting of the particles of the polyimide polymer has a toughness≥0.80 Ksi, a specific gravity of ≥1.38 g/cm³, or a toughness≥0.80 Ksi and a specific gravity of ≥1.4 g/cm³.

3. The polyimide composition according to claim 1, wherein the sum of the mole fractions of BPDA and PMDA in the particles of the polyimide polymer is about 1 and the sum of the mole fractions of PPD and ODA in the particles of the polyimide polymer is about 1, and wherein the relationship of the mole fraction of BPDA and mole fraction PPD in the particles of the polyimide polymer is in the range of PPD−0.2<BPDA<PPD+0.2.

4. The polyimide composition according to claim 1, comprising:
a polyimide comprising one or more of the following repeat units

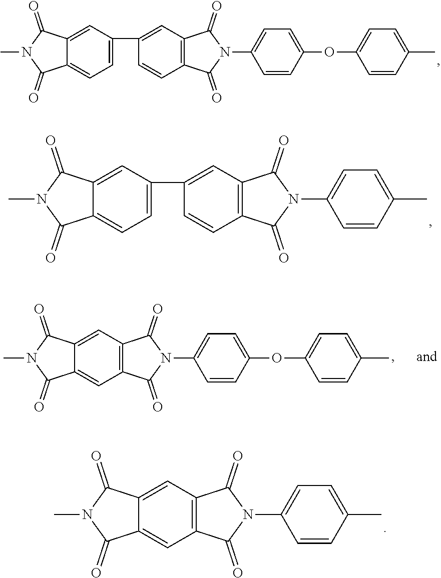

5. The polyimide composition according to claim 1, wherein the polyimide composition comprises a filler, wherein the filler is present at up to 75% (w/w), based on the weight of the polyimide composition.

6. The polyimide composition according to claim 5, wherein the filler is graphite or clay.

7. A part, comprising: the polyimide composition according to claim 1.

8. The part according to claim 7, wherein the polyimide composition is molded to form the part.

9. The part according to claim 7, wherein the part is a clutch roller, a seal ring, spherical washer, compressor seal, lip seal, valve seat, ball bearing cage, and actuating disc.

10. A method of making a polyimide composition, comprising:
combining (i) ODA, (ii) PMDA, (iii) PPD, (iv) BPDA and (v) a solvent for a time and at conditions sufficient to form a reaction product comprising a polyamide and solvent;
heating the reaction product at a temperature and time sufficient to remove water and to form particles of a polyimide;
filtering and washing the formed particles of polyimide;
drying the washed polyimide particles to form the polyimide composition, wherein the polyimide composition comprises the particles of polyimide;
wherein when the polyimide composition consists of the particles of the polyimide polymer, the polyimide composition has an apparent density of ≤0.25 grams per cubic centimeter.
